(19) United States
(12) Patent Application Publication
(10) Pub. No.: US 2025/0042756 A1
(43) Pub. Date: Feb. 6, 2025

(54) SEQUESTRATION OF CO2

(71) Applicant: OLIMENT® GmbH, Rötha OT Espenhain (DE)

(72) Inventor: Frank BELLMANN, Weimar (DE)

(73) Assignee: OLIMENT® GmbH, Rötha OT Espenhain (DE)

(21) Appl. No.: 18/720,389

(22) PCT Filed: Jan. 12, 2022
(86) PCT No.: PCT/EP2022/050562

§ 371 Date: Jun. 14, 2024

(51) Int. Cl. C01F 5/24; C04B 28/10

(52) U.S. Cl. CPC C01F 5/24; C04B 28/105

(57) ABSTRACT

The invention relates to a method for sequestering CO₂, which comprises the steps of providing a starting product comprising at least 20% by mass of one or more of the following components, ultramafic rocks, weathering products of ultramafic rocks, olivine and/or industrial waste materials, homogenizing the starting product and hydro-thermally treating the homogenized starting product in a heat treatment apparatus at a temperature of above 100° C. for at least 24 hours. Furthermore, the converted starting product is dewatered of bound water by means of thermal treatment and/or reaction grinding. Subsequently, the product thus obtained is contacted with CO₂, wherein the latter is bound.

The invention relates to a method for sequestering CO₂.

Carbon dioxide (CO₂) acts as a greenhouse gas in the atmosphere and is considered to be one of the main causes of man-made global warming. In addition to the fundamental reduction of CO₂ emissions, parallel efforts are being made to bind CO₂ already being in the atmosphere. Binding CO₂ can also be used to make manufacturing processes that produce large quantities of CO₂, such as cement production, CO₂-neutral.

Sequestration of CO₂ refers, in particular to the removal of CO₂ from the atmosphere, ideally in such a way that the CO₂ is combined with other substances so that it cannot escape again. Various proposals are known for this. One possibility is to use olivine.

Olivine is a mineral of the general composition A₂[SiO₄], wherein various divalent ions can occur for A, such as magnesium (forsterite, Mg₂SiO₄), iron (Fe₂SiO₄, fayalite), manganese (Mn₂SiO₄, tephroite) as well as other ions and a combination of the various cations, as olivine is a solid solution series.

The patent literature on accelerating a sequestration of carbon dioxide in a reaction with olivine is very extensive. Many method for sequestering CO₂ by using olivine are based on the following principle and differ mainly in the way as the reaction is accelerated.

Mg₂SiO₄+2CO₂→2MgCO₃+SiO₂

According to WO 2007/069902, the reaction should be accelerated by grinding and adjusting certain pH values, WO 2008/140821 and WO2008/061305 suggest accelerating the reaction by high temperatures, high CO₂ partial pressures and high fineness of the olivine. WO 2008/101293 proposes the addition of ammonium, WO 2007/106883 the addition of a base and U.S. Pat. No. 4,944,928 the addition of hydrochloric acid. In addition to these methods, there are a large number of other methods that are capable of accelerating the sequestration of carbon dioxide during the reaction with olivine, wherein all of these processes use complicated technologies and expensive starting materials.

In the project named CO₂ min, an attempt was made to combine such a carbonation of olivine with cement production. The aim is to separate CO₂ emissions from the cement industry by carbonating olivine. As a result, cement production will continue unchanged while retaining the existing high-temperature process. The resulting carbon dioxide is bound by a reaction with olivine in the form of magnesium carbonate and SiO₂. This incurred material can then be added to the cement and thus disposed of.

However, it is obviously not possible to convert the olivine completely into magnesium carbonate, see D. Kremer, H. Wotruba: Separation of products from mineral sequestration of CO₂ with primary and secondary materials. Minerals, Volume 10 (2020), 1098 ff. Very high CO₂ partial pressures (17 bar) and high temperatures (175° C.) were used in the project. Despite the autoclave treatment, the degree of conversion of the olivine was only 23% and very large quantities of olivine would be needed to compensate for the low degree of conversion. The selected process technology is also probably not suitable for binding carbon dioxide on an industrial scale.

Another idea for binding carbon dioxide through a reaction with olivine was also developed in the Netherlands, see R. D. Schuiling, P. Krijgsman: Enhanced weathering: An effective and cheap tool to sequester CO₂. Climate change, Vol. 74 (2006), 349-354. Thereby, olivine is spread on arable land or distributed on beaches.

If the olivine is dissolved in magnesium ions, the rainwater or seawater could simultaneously absorb carbon dioxide in the form of HCO₃⁻ ions according to the following equation.

Mg₂SiO₄+4CO₂+2H₂O→2Mg²⁺+4HCO₃⁻+SiO₂

However, a laboratory experiment at the University of Hamburg showed that the described reaction does not take place in the form described. Even if the world's entire arable land were sprinkled with olivine, only 0.2% of global carbon dioxide emissions could be captured, see T. Amann et al. Enhanced weathering and related element fluxes—a cropland mesocosm approach. Biogeosciences, Volume 17 (2020), 103-109.

The object underlying the invention is therefore that of providing an efficient method for sequestering CO₂.

According to the invention, this object is achieved by a method having the features of claim 1.

Further advantageous embodiments are specified in the dependent claims, the further description and the exemplary embodiments.

According to claim 1, it is provided that first a starting product is provided, which comprises at least 20% by mass, preferably at least 40% by mass, more preferably at least 60% by mass, still more preferably at least 80% by mass, of one or more of the following components. These components may be ultramafic rocks such as dunite, weathering products of ultramafic rocks such as serpentinite, olivine or industrial waste materials. It is essential that all of these raw materials each have a MgO concentration or a MgO content of at least 10% by mass, preferably 20% by mass and even more preferably more than 30% by mass and ideally more than 40% by mass. This starting product is provided with a fineness corresponding to a BET surface area of 0.1 m²/g or finer. A BET surface area of 0.5 m²/g is advantageous, and even more preferably a BET surface area of 1.0 m²/g or even finer.

An important mineral in ultramafic rocks is olivine. This is a mixed crystal series between fayalite (Fe₂SiO₄), forsterite (Mg₂SiO₄), tephroite (Mn₂SiO₄) and other minerals of the form A₂[SiO₄]. Natural olivine deposits are documented and the olivine is often a magnesium-rich material with iron content.

Examples of industrial waste materials that can be used in the context of the invention are foundry sand or refractory materials.

Once the starting product has been provided, the starting product is subsequently homogenized if necessary. The mentioned, possible components of the starting product are often natural rocks or materials from natural deposits. Experience has shown that these are neither available in pure form nor homogenized. Homogenization can be carried out using a mixer, for example, or at the same time as crushing to the desired fineness.

Following homogenization, the starting product prepared in this way is hydro-thermally treated. This takes place in a heat treatment apparatus at a temperature of more than 100° C. for at least 24 hours. The heat treatment apparatus can be a heat tunnel, for example, but can also be an autoclave. An autoclave is usually understood to be a gas-tight, sealable pressure vessel that can be used for the thermal treatment of substances in the overpressure range. It is preferable for the heat treatment apparatus to be understood as a vessel, a combination of devices, such as an oven and a sealed mold, or a device for enclosing a volume. The treatment preferably takes place at temperatures above 100° C., in particular above 150° C. and even more preferably above 250° C. It is advantageous for good conversion if the treatment is carried out for longer than 36 hours, even more preferably longer than 48 hours. However, particularly good results can be achieved if the treatment is carried out still longer, over several days, for example 4, more preferably 7 days or longer.

Furthermore, water is added to the homogenized starting product by adding water directly before, after and/or simultaneously with the homogenization in the previous step and mixing the water with the starting product. Alternatively or additionally, steam can also be introduced into the heat treatment apparatus.

During the hydrothermal treatment of the homogenized starting product, it is at least partially converted into magnesium hydroxide (Mg(OH)₂) and magnesium silicate hydrates (Mg₃Si₂O₅(OH)₄, Mg₃Si₄O₁₀(OH)₂) by the presence of H₂O. The underlying reactions are here as follows, wherein these are given here in simplified form starting from forsterite (Mg₂SiO₄):

2Mg₂SiO₄+3H₂O→Mg₃Si₂O₅(OH)₄+Mg(OH)₂ (1)

3Mg₂SiO₄+5SiO₂+2H₂O→2Mg₃Si₄O₁₀(OH)₂ (2)

wherein reaction (1) primarily takes place. This is also preferred in the context of the invention, since Mg₃Si₂O₅(OH)₄ is better suited for binding CO₂ than Mg₃Si₄O₁₀(OH)₂. It should also be noted that the amount of the respective products and their ratio depends, among other things, on the exact composition of the starting product.

The magnesium hydroxide (Mg(OH)₂) can be present as brucite. The magnesium silicate hydrate (Mg₃Si₂O₅(OH)₄, Mg₃Si₄O₁₀(OH)₂) can be present in the form of lizardite, antigorite, talc and other forms. It should be noted here that the stoichiometric water content is sometimes lower—in the range of 13% by mass for antigorite—than that which can be determined by testing—in the range of 16% by mass to 20% by mass. This can be explained by the fact that some of the materials are so fine that water can also adhere to their surface.

Similarly, such deviations from the stoichiometry also apply to the ratio between Mg and Si. Furthermore, foreign ions, such as Fe, can also be incorporated into the reaction products. However, other reaction products such as hydromagnesite, hematite, magnetite or gibbsite can also be formed. This depends in each case on the exact composition of the starting product. All or some of the reaction products may contain iron, carbonate and alkalis or other foreign ions.

The converted starting product is then at least partially dewatered of bound water by means of thermal treatment and/or reaction grinding. Bound water is sometimes also referred to as water of crystallization. It must be distinguished from unbound water, which can be regarded as free H₂O. Complete dewatering can be achieved at great expense. According to the invention, the water content of bound water should be reduced by at least 60%, preferably by at least 80%, even more preferably by at least 90%.

For thermal treatment, the converted starting product can be heated to a temperature between 180° C. and 1000° C. Depending on the fineness present, heating for just a few minutes is sufficient. Temperatures between 300° C. and 800° C. are preferred, even more advantageously between 500° C. and 700° C. Alternatively or additionally, the converted starting product can also be subjected to reaction grinding to rearrange the crystal structures. In so-called reaction grinding, crystalline water can also be removed from the converted starting product by rearranging the crystal structures. For this purpose, auxiliary material such as quartz can be added to the grinding process.

In this step, the magnesium hydroxide (Mg(OH)₂) present in the converted starting product is at least partially converted into magnesium oxide (MgO) and the present magnesium silicate hydrate (Mg₃Si₂O₅(OH)₄, Mg₃Si₄O₁₀(OH)₂) is at least partially converted into dewatered magnesium silicate hydrate, which can be illustrated in a simplified manner as xMgO·SiO₂ yH₂O. Dewatering, also called dehydration, here refers to the reduction of crystalline water or water of crystallization in the converted starting product.

The underlying chemical processes here are, again simplified, as follows:

Mg(OH)₂→MgO+H₂O (3)

Mg₃Si₂O₅(OH)₄→2xMgO·SiO₂·yH₂O+zH₂O (4)

Mg₃Si₄O₁₀(OH)₂→2aMgO·SiO₂·bH₂O+cH₂O (5)

wherein (4) produces a largely amorphous reaction product with a Mg to Si ratio of 1.5 to 2 and a bound water content of around 3%. The reaction product formed in equation (5) has an even lower Mg to Si ratio. Hence also the variables a, b, c, x, y and z. This depends in each case on the exact composition of the starting product and the treatment parameters.

After dewatering, the water content of the bound water in the converted, dewatered starting product is preferably less than 10% by mass, more advantageously less than 5% by mass, even more preferably less than 3.5% by mass, still more preferably less than 2.5% by mass.

The transformed and dewatered starting product is therefore present as a multiphase product. Other possible secondary phases are hematite, magnetite, enstatite, feldspars, pyroxenes, quartz and amorphous phases.

Once the converted starting product has been dewatered, it is contacted with CO₂.

Here, the CO₂ reacts with the magnesium oxide (MgO) present, the dewatered magnesium silicate hydrate (xMgO·SiO₂ yH₂O) present and/or the magnesium hydroxide (Mg(OH)₂) present. The CO₂ is mainly bound in the resulting magnesium carbonate (MgCO₃) and/or magnesium carbonate hydrate (MgCO₃-mH₂O).

The underlying chemical processes are shown in a simplified and generalized manner as follows:

MgO+CO₂+mH₂O+MgCO₃·mH₂O (6)

xMgO·SiO₂·yH₂O+qH₂O+xCO₂→xMgCO₃·(q+y)/xH₂O+SiO₂ (7)

Mg₂SiO₄+2CO₂+2nH₂O→2MgCO₃·nH₂O+SiO₂ (8)

Mg(OH)₂+CO₂+p−1H₂O→MgCO₃·pH₂O (9)

where m, n, p, q, x and y represent corresponding variables. Some of these can be zero. It should also be noted that in equation (7) the dewatered magnesium silicate hydrate still only appears as xMgO·SiO₂ yH₂O, as it has been (incompletely) dewatered. Equation (8) shows forsterite (Mg₂SiO₄), which may still be present. Forsterite from the starting material may still be present at this time. It should also be noted that the xMgO·SiO₂·yH₂O is very similar to forsterite and can be regarded as amorphous forsterite in simplified terms.

If a starting product is provided which already contains at least 20% by mass magnesium silicate hydrate, preferably at least 40% by mass, more preferably at least 60% by mass, even more preferably at least 80% by mass, as is the case with serpentinite, for example, the steps of adding water and hydrothermal treatment can be dispensed with. Serpentinite is a metamorphic rock which is formed by natural transformation, in particular weathering, of ultramafic rocks.

According to the invention, it was recognized that by combining a hydro-thermal treatment and the expulsion of crystal water from natural materials, such as ultramafic rocks, an intermediate material can be produced which is suitable for binding CO₂ to a high degree.

The olivine-rich rocks that can be used according to the invention include, for example, dunite, wehrlite and habsburgite. These rocks often have a low degree of weathering. However, weathered rocks with a similar chemical composition and a higher water content can also be used. Weathered rocks include serpentinite, for example.

In this way, large quantities of CO₂ can be bound with relatively little energy input. For example, it is possible to bind approx. 0.6 t of CO₂ within a few hours with approx. 1 t of forsterite by using the method according to the invention.

The hydro-thermal treatment of the homogenized starting product for conversion into magnesium hydroxide and/or magnesium silicate hydrate is one of the method steps which, according to the invention, takes the longest time. It is therefore preferable if one or more treatments are carried out during the hydrothermal treatment to accelerate the reactions taking place. Various treatment methods are available for this purpose, which can be carried out individually or in combination with one another. These are explained in more detail below. All but also only some selected of the listed treatment methods can be combined with each other.

One possibility is to crush or break up the homogenized starting product continuously or discontinuously, in particular to grind it very finely, during the hydro-thermal treatment or between several hydro-thermal treatments in the heat treatment apparatus in order to accelerate the conversion.

Continuous or discontinuous crushing can prevent or reduce clumping or coalescence of the substances present during hydrothermal treatment. This ensures that there is still a sufficiently large surface area for the processes described above can take place. Several options are available for exact implementation.

On the one hand, it is possible to interrupt the hydro-thermal treatment, convey the material out of the heat treatment apparatus and to crush or break it up, for example grind it, and feed it back again into the heat treatment apparatus.

On the other hand, it is also possible to provide a corresponding crushing system in the heat treatment apparatus, which performs the crushing continuously or discontinuously during the hydrothermal treatment.

Another option is to operate a heat treatment apparatus, in particular continuously, and to discharge some of the material from the heat treatment apparatus during the hydrothermal treatment, to crush it and feed it back again into the device. This is particularly useful if the starting product is present in a suspension in the heat treatment apparatus or at least in a pumpable form. In this case, for example, a line can be provided from an autoclave that leads to a crushing device such as a mill and back again into the autoclave, which is an example of a heat treatment apparatus within the meaning of the invention. In this case, one can speak of a circulation process without interruption.

Another option is to add nucleating agents, agents to raise the pH value, foreign ions and/or other auxiliary material to the starting product at the beginning, before or during homogenization or directly after homogenization or also just in the heat treatment apparatus to accelerate the process of the reactions.

For example, brucite, lizardite, antigorite, pre-hydrated olivine-containing rock or mixtures of these substances can be added as nucleating agents. The addition of at least 2% by mass of nucleating agents is preferred.

Substances that release NaOH, KOH, NaCl, KCl, Na₂SO₄, MgSO₄, K₂SO₄, Na₂CO₃, Ca(OH)₂ and/or K₂CO₃ after their addition can be added as agents for raising the pH value, which thus modify a solution in which the reaction takes place, by which the pH value in the solution raises so that the reaction takes place more quickly.

Other additives that also accelerate the reaction are for example magnesite, hydromagnesite, nesquehonite, dolomite, SiO₂, feldspars, pyroxenes and mixtures thereof, wherein the addition of these substances can lead to the formation of new reaction products. Examples of foreign ions are aluminum, sulfate or alkalis. Here, too, new reaction products can be formed.

In order to increase the purity of the resulting product for CO₂ sequestration, these auxiliary materials can be at least partially removed again after the hydrothermal treatment has been completed.

In principle, the reaction process can also be realized by increasing the temperature. In particular, temperatures above 150° C., preferably above 200° C. and more preferably above 250° C. are possible.

An additional way to accelerate the reaction is if the homogenized starting product is present in a suspension for hydro-thermal treatment of the homogenized starting product in the heat treatment apparatus, which suspension is stirred continuously or discontinuously during the hydro-thermal treatment. For example, an agitator can be provided here, which ensures movement of the suspension.

In this context, grinding can also be provided alternatively or additionally—as described above. Wet grinding is particularly suitable here, so that a part of the suspension can be transported out of the heat treatment apparatus, is wet ground and is added back again into it. However, wet grinding can also be carried out directly in the heat treatment apparatus.

Another alternative is ultrasonic treatment of the homogenized starting product. In a similar way to crushing, this ensures that substances formed on the starting product, such as magnesium hydroxide and/or magnesium silicate hydrate, separate from the remaining substances in the starting product so that again a sufficiently large surface area is available to allow the reaction to proceed quickly. This can be done, for example, using an ultrasonic horn or similar.

Depending on the desired further treatment and processing of the homogenized and converted starting product, it may be useful to carry out drying to remove unbound water before the dewatering step, i.e. the separation of bound water. This is particularly then indicated and useful if the hydro-thermal treatment of the starting product was carried out in an aqueous suspension.

The dried starting product can then be fed to the dewatering step. The thermal treatment proposed for this purpose can also be referred to as tempering or calcination. It can be carried out in a rotary kiln or by means of a circulating fluidized bed of hot gases. When using a fluidized bed, dewatering occurs within a few seconds. Alternatively, the necessary energy can also be applied electrically, for example in a muffle furnace. In this case, times of around 5 minutes to 10 minutes are required. In principle, open systems with flames, for example, are preferable, as it is here easier to remove the resulting water vapor, which speeds up the reaction.

In principle, it is sufficient for the converted and dewatered starting product to come into contact with CO₂, such as is present in the air, for it to form a bind with the CO₂. However, the binding process can be intensified and accelerated if the contacting of the converted, dewatered starting product with CO₂ in an aqueous suspension is carried out by blowing in CO₂-containing gas such as air, for example. It has been shown that this method step makes it possible to bind the CO₂ more quickly than if it is treated purely with normal ambient air in the absence of water.

Contacting the converted, dewatered starting product with a CO₂-containing gas can be carried out at partial pressures of at least 200 ppm, 400 ppm, 1000 ppm, 10,000 ppm, 100,000 ppm, 200,000 ppm, in particular already at room pressure or in the range of maximum 2 bar, which corresponds to 2 million ppm. According to the invention, it is not necessary to provide high pressures, in order to achieve rapid and sufficient binding of the CO₂. However, the binding of the CO₂ is further accelerated by higher partial pressures.

To provide the starting product with a fineness corresponding to a BET surface area of 0.1 m²/g or finer, it is preferable if the starting product is subjected to grinding, in particular wet grinding. The starting product is usually not available in a higher fineness, even if it is in part already very fine due to natural weathering. This fineness can easily be increased by grinding. Wet grinding is also preferred here, as it is often more energy-efficient than dry grinding. Since the starting product is then subjected to a hydro-thermal treatment in which it is contacted with water, the advantage of wet grinding can already be utilized in this step, especially since the ground material does not have to be dried.

The converted and dewatered starting product can be used as a binder, for example as a complete or partial cement substitute, for concrete production before the CO₂ is bound. Here, the water/binder ratio is preferably in the range of 1:2 or less. This means that the ratio is 1:2.22, preferably 1:2.5 and ideally 1:2.86 and even better 1:3.33 or less. It has been found that a higher ratio, i.e. a higher proportion of water, prolongs hardening and reduces strength. The concrete produced in this way already binds CO₂ from the ambient air already at room air and room temperature. In principle, the binding process can still be accelerated by heat or pressure treatment.

In an alternative embodiment, the converted, dewatered and CO₂-bound starting product can preferably be or be solidified and fed as aggregate or filler for the production of concrete and/or mortar. After the CO₂ has been bound, it can be dried again. However, this is not absolutely necessary, as a solid is already formed from the converted and dewatered starting product during the binding of the CO₂ or the strength of the hardened material continues to increase.

The resulting material is inert and is suitable for further processing into concrete together with a hydraulic binder, such as cement clinker. Further crushing may be necessary for this. In principle, it is advantageous for the process of the method according to the invention if at least the starting product is free of cement clinker. In particular, this can mean that it has no or hardly any (less than 0.1% by mass) alite and/or belite phases. Experience has shown that the materials present in the cement clinker partially slow down the reactions explained here, so that their presence is not desirable. In small quantities, however, cement clinker is harmless.

Optionally, other substances can be added to improve the reactivity or modify the properties of the hardened material. These substances include organic additives, in particular superplasticizers, rock flours, in particular limestone, dolomite and olivine, pozzolanic additives such as trass, glass powder, coal fly ash and/or thermally activated clays.

The starting products provided according to the invention are usually not pure substances, so that impurities are present to a high degree. However, it is advantageous if at least the molar ratio of Mg to Ca is 10:1 or greater and/or the molar ratio of Si to Al is also 10:1 or greater. It has been shown that the presence of calcium and aluminum each in relation to magnesium and silicon respectively slows down the reactions or in some cases brings them to a complete standstill. It is therefore not insignificant to shift the corresponding molar ratios significantly in the direction of magnesium or respectively silicon. Preferably, the molar ratio of Mg to Ca is at least 20:1 and/or the molar ratio of Si to Al is at least 20:1.

The invention is explained in more detail below with reference to the figures based on exemplary embodiments. The figures show:

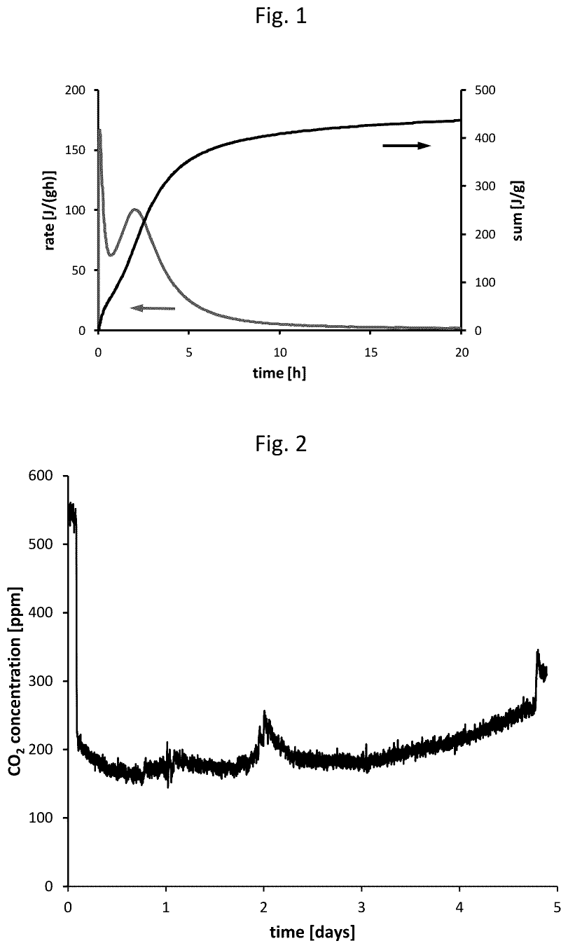

FIG. 1 a hydration process of a product produced by the method according to the invention; and

FIG. 2 a curve of a CO₂ concentration during the binding of CO₂ by a product manufactured by using the method according to the invention.

To verify the invention, the tests described in more detail below were carried out, among other things. Here, pure forsterite was used in the first test on the one hand and natural olivine in the second test.

### Pure Forsterit

For the first study, pure forsterite (Mg₂SiO₄) was used, which was produced by firing a mixture of magnesium hydroxide carbonate and amorphous SiO₂ in a laboratory furnace. After firing, the starting material was ground in a vibrating disk mill. The specific surface area after the BET process was 1 m²/g.

A mixture of forsterite and 1-molar NaOH solution in a ratio of 1:2.2 was prepared and treated in an autoclave at a temperature of 200° C. In the meantime, the reaction was interrupted and the material was dried and ground. After a treatment period of 4 weeks, no forsterite was detectable in the treated and washed material using X-ray phase analysis. The loss on ignition after completion of the autoclave treatment was 19.3% by mass.

Of the dried and ground material, 3.0 g was fired in a platinum crucible at a temperature of 450° C., 600° C. and respectively 750° C. in each case for one hour in a muffle furnace. The samples showed a loss on ignition of 13.5% (450° C.), 2.8% (600° C.) and 0.52% (750° C.) respectively.

### Sequestration

This material was used to sequester CO₂. For this purpose, 1 g of the sample fired at 600° C. was placed in a beaker glass with 50 g of water and the suspension was stirred continuously. At the same time, gaseous CO₂ (concentration 100%) was introduced into the suspension. After 6 hours, the suspension was separated by filtration and the solid was analyzed after drying by means of X-ray diffraction and ²⁹Si MAS NMR.

X-ray phase analysis showed nesquehonite (MgCO₃·3H₂O) as the only crystalline reaction product. Using ²⁹Si MAS NMR, it could be shown that all the silicon was present as amorphous SiO₂. The following reaction can thus be demonstrated, wherein only the initial and final states are shown and the intermediate steps are omitted:

Mg₂SiO₄+6H₂O+2CO₂→2MgCO₃·3H₂O+SiO₂

Accordingly, carbon dioxide can be sequestered using the method according to the invention.

### Binder

The reactivity of the material before sequestering as a binder was investigated by determining the water binding after 7 days of hydration. For this purpose, the materials fired at different temperatures were ground in a hand mortar and mixed with water using a water-binder ratio of 0.50 (1:2) and stored for 7 days in closed containers at 22° C. Thereafter, the hydration of the samples was then stopped by drying at 60° C. and the loss of ignition was determined by means of thermal analysis.

This resulted in ignition losses of 20.5% (450° C.), 25.3% (600° C.) and 7.1% (750° C.) respectively. Accordingly, all three binders have hydrated and bound water.

The hydration process of the sample fired at 600° C. was analyzed by calorimetry (DCA) at 25° C. This process showed a very fast reaction with a maximum of the main hydration phase after about 2 hours, wherein the reaction was completed after less than 24 hours. A total heat of about 450 J/g was released as shown in FIG. 1.

As a result, the binder reacts faster than most conventional cements. An examination of the hydrated and dried sample after DCA analysis using ²⁹Si MAS NMR spectroscopy showed that all the silicon was present as magnesium silicate hydrate.

### Natural Olivine

Natural olivine from a site in Norway was used for the second study. Its chemical analysis revealed the following composition: 41.9% SiO₂, 49.9% MgO, 6.9% Fe₂O₃, 0.6% Al₂O₃, 0.1% CaO, 0.5% loss on ignition.

The material was ground in a ball mill to a fineness of 7300 cm²/g Blaine and mixed with 1-molar NaOH solution in a ratio of 1:2. The material was treated in an autoclave at 200° C. for 22 days, wherein this was interrupted once to grind the material.

After autoclave treatment, the intermediate product was dried, ground and the loss on ignition was analyzed (16.3%).

### Sequestration

The sequestration of carbon dioxide was then investigated. For this purpose, 10 g of an intermediate product fired at 600° C. was used, which had been ground after thermal treatment for 4 minutes in the disk vibrating mill at 700 revolutions per minute with the addition of triethanolamine. The olivine pre-treated according to the invention was added to 1 liter of water and stirred continuously. Normal ambient air was blown into this suspension by using a simple aquarium pump. Ambient air has a CO₂ concentration of around 400 ppm. In closed rooms, the CO₂ concentration is usually somewhat higher and is usually 500 to 600 ppm.

During the experiment, the CO₂ concentration in the air rising from the suspension was measured. This fell continuously and very quickly during the experiment to a concentration of around 200 ppm. It was possible to remove carbon dioxide from the air introduced over several days. Accordingly, the material is able to react with CO₂ from the air and bind it permanently in the form of magnesium carbonate. This is shown in FIG. 2.

### Binder

Individual batches of the intermediate product were fired at different temperatures and the water binding was investigated by hydration for 7 days at 22° C. Before hydration, the loss of ignition (6.8% after 550° C., 3.1% after 600° C., 2.2% after 650° C., 1.7% after 700° C.) was lower than after reaction with water and subsequent drying at 60° C. (20.1% after 550° C., 23.7% after 600° C., 24.7% after 650° C., 22.8% after 700° C.).

Consequently, natural material such as olivine can also be used for binder production, wherein hydration after the described pre-treatment could be demonstrated.

Accordingly, it was shown that it is possible to bind CO₂ efficiently using the method according to the invention. In addition, it is possible to produce a binder for concrete production as a by-product, which can also be used for CO₂ sequestration.

1. A method for sequestering CO₂, comprising the steps of:
a) providing a starting product comprising at least 20% by mass of one or more of the following components:
ultramafic rocks, especially dunite,
weathering products of ultramafic rocks, especially serpentinite,
olivine,
industrial waste materials,
each with an MgO concentration of at least 10% by mass and with a fineness corresponding to a BET surface area of 0.1 m²/g or finer,
b) homogenizing the starting product,
c) hydro-thermally treating the homogenized starting product in a heat treatment apparatus at a temperature of more than 100° C. for at least 24 hours,
d) adding water to the homogenized starting product by adding water directly before, after and/or simultaneously with the homogenization in step b) and mixing the water with the starting product and/or introducing steam into the heat treatment apparatus,
wherein after step c) the starting product was at least partially converted into magnesium hydroxide Mg(OH)₂ and/or magnesium silicate hydrate in the presence of H₂O,
e) at least partial dewatering of the converted starting product from bound water by means of thermal treatment and/or reaction milling,
wherein the converted starting product is treated at a temperature between 180° C. and 1000° C. during thermal treatment,
wherein a rearrangement of the crystal structures in the converted starting product occurs during reaction grinding,
wherein, after step e), magnesium hydroxide present in the converted, dewatered starting product is at least partially dewatered into magnesium oxide, and magnesium silicate hydrate present is at least partially dewatered and can thereby be converted into dewatered magnesium silicate hydrate,
f) contacting the converted, dewatered starting product with CO₂, wherein CO₂ reacts with the magnesium oxide, the dewatered magnesium silicate hydrate and/or the magnesium hydroxide and the CO₂ is bound in the resulting magnesium carbonate and/or magnesium carbonate hydrate,
wherein steps c) and d) can be omitted when preparing a starting product which already contains at least 20% by mass magnesium silicate hydrate, for example serpentinite.

2. The method according to claim 1,
wherein
for at least partial conversion of the starting product in step c), one or more treatments are carried out to accelerate the reactions taking place during the hydrothermal treatment.

3. The method according to claim 1,
wherein
during the hydro-thermal treatment or between several hydro-thermal treatments in the heat treatment apparatus in step c), the homogenized starting product is continuously or discontinuously crushed, in particular finely ground, to accelerate the conversion.

4. The method according to claim 1,
wherein
nucleating agents, agents for raising the pH value, foreign ions and/or auxiliary substances are added to the starting product in step a), b), c) and/or d).

5. The method according to claim 4,
wherein
after step c) the auxiliary substances are at least partially removed again.

6. The method according to claim 1,
wherein
for hydro-thermal treatment of the homogenized starting product in the heat treatment apparatus, the homogenized starting product is present in a suspension which is stirred continuously and/or discontinuously during the hydrothermal treatment.

7. The method according to claim 1, wherein
in step c), an ultrasonic treatment of the homogenized starting product is carried out.

8. The method according to claim 1,
wherein
the contacting of the converted, dewatered starting product with CO₂ in step f) is carried out in an aqueous suspension by blowing in CO₂-containing gas.

9. The method according to claim 1,
wherein
the contacting of the converted, dewatered starting product with a gas containing CO₂ is carried out at partial pressures of at least 200 ppm, in particular at room pressure.

10. The method according to claim 1,
wherein
the converted starting product is subjected to drying to remove unbound water before step e).

11. The method according to claim 1,
wherein,
in order to provide the starting product with a fineness corresponding to a BET surface area of 0.1 m²/g or finer, the starting product is subjected to grinding, in particular wet grinding.

12. The method according to claim 1,
wherein
after step f), the converted, dewatered and CO₂-bound starting product is/becomes solidified and is fed as an aggregate or as a filler for the production of concrete and/or mortar.

13. The method according to claim 1,
wherein
after step e) the converted, dewatered starting product is used as a binder for the production of concrete, wherein the water-binder ratio is 1:2 or less.

14. The method according to claim 1,
wherein
the starting product has a molar ratio of Mg to Ca of 10:1 or greater and/or a molar ratio of Si to Al of 10:1 or greater.
